(19) United States
(12) Patent Application Publication
(10) Pub. No.: US 2026/0166410 A1
(43) Pub. Date: Jun. 18, 2026

(54) PORTABLE SCOREBOARD WITH HANGERS AND PROTECTIVE COVER AND RELATED METHOD OF USE

(71) Applicant: 70 Main Street Inc, Toronto (CA)

(72) Inventors: John SMID, Toronto (CA); Charles SMID, Toronto (CA)

(21) Appl. No.: 18/978,438

(22) Filed: Dec. 12, 2024

(51) Int. Cl. A63B 71/06

(52) U.S. Cl. CPC A63B 71/0669; A63B 2225/00

(57) ABSTRACT

A portable scoreboard comprises a generally prismatic shaped housing, a display(s) supported on the front of the housing and configured to indicate a score(s), and a controller operatively connected to the display(s) to determine the score(s) to be indicated thereon. The scoreboard features hangers on the back of the housing for passing through openings formed by woven wire of the fencing to hang the housing thereon. A lower portion of the housing back is arranged to engage the fencing to cooperate with the hangers in the scoreboard's mounted position. The scoreboard also features a protective cover supported on the housing front and movable relative thereto between a stored position covering the display(s) and a display position disposed to one side thereof as not to be visually obstructing. A side of the cover facing away from the housing in the display position is arranged to receive advertisement indicia.

### TECHNICAL FIELD

The following relates, generally, to a portable scoreboard, and more particularly to such a scoreboard with hangers and a protective cover, as well as a related method of use.

### BACKGROUND

In amateur outdoor sports, it is challenging to communicate a score of a sports match as a field of play of the sports match often has minimal infrastructure, which usually does not include a scoreboard. Typically, such infrastructure includes chain link fencing acting as a barrier between the field of play and a spectating area where spectators are located to view the match.

### SUMMARY

According to an aspect of the invention, there is provided a portable scoreboard for use with chain link fencing having a mesh of woven wire, the portable scoreboard comprising:
a housing which is generally prismatic in shape and having a front, a back opposite to the front, a top, a bottom opposite to the top, and opposite sides;
at least one display supported on the front of the housing and configured to indicate at least one score;
a controller supported by the housing and operatively connected to said at least one display, wherein the controller is configured to determine said at least one score to be indicated on said at least one display; and
hangers supported on the back of the housing for passing through openings formed by the mesh of woven wire of the chain link fencing to hang the housing thereon, wherein the hangers are in the form of fingers each having a proximal end at or adjacent an attachment point of the finger to the housing and an opposite distal end which is free, wherein the hangers are respectively movable relative to the housing between a retracted position in which the distal end is located at or adjacent a surface of the back of the housing and an extended position in which the distal end is in outwardly spaced relation to the surface of the back of the housing to provide an underside of the hanger for engaging the chain link fencing in a mounted position of the scoreboard;
wherein a lower portion of the back of the housing between the hangers and the bottom is arranged to engage the chain link fencing to cooperate with the hangers in the mounted position of the scoreboard.

This provides an arrangement of scoreboard suited for hanging on chain link fencing to display score(s).

Preferably, the hangers are pivotally attached to the housing and the housing includes, for each hanger, a knuckle defining a pair of contiguous limit surfaces for engaging the underside of the hanger to restrict pivotal movement of the hanger between the retracted and extended positions.

Preferably, the knuckle includes a ridge between respective ones of the pair of limit surfaces and an interior face of the underside of the hanger is planar such that the ridge acts to bias the hanger against pivotal movement between the retracted and extended positions.

In the illustrated arrangement, each knuckle is received in a receptacle in the back of the housing to be recessed relative to the surface thereof and the underside of each hanger has a cutout configured to mateably receive the knuckle in the retracted position such that an outer surface of the hanger, opposite to the underside thereof, is substantially flush with the surface of the back of the housing in the retracted position.

Preferably, the cutouts are enlarged relative to the knuckles proximal to the proximal ends of the hangers to provide clearance for pivotal movement to the extended position.

Preferably, the scoreboard further includes stops distinct from the knuckles for butting engagement with the undersides of the hangers in the retracted position, wherein the stops are disposed in spaced relation to the knuckles to engage the hangers at intermediary locations thereon between the proximal and distal ends.

Preferably, each hanger at the proximal end thereof has an inclined end surface between the underside and an outer surface and configured to engage the housing in the extended position. Thus the hanger is further braced or supported in the extended position.

In the extended position, the hangers preferably extend outwardly and downwardly from the back of the housing. Thus is formed an acute interior corner between the underside of the respective hanger and the back of the housing.

Preferably, when the hangers have intermediate portions between the proximal and distal ends extending downwardly and outwardly from the back of the housing in the extended position, the hangers further include distal end portions, which define the distal ends, extending downwardly from the intermediate portions in the extended position to form hooks.

Preferably, each hanger includes plural grooves in an outer surface thereof opposite to the underside, wherein the grooves respectively extend between opposite sides of the hangers and are disposed in spaced relation to each other in a longitudinal direction between the proximal and distal ends to be arranged for gripping engagement by a user's fingers.

In the illustrated arrangement, the grooves are disposed closer to the proximal end than to the distal end of the hanger.

In the illustrated arrangement, when the hangers are pivotally attached to the housing and the housing includes, for each hanger, a knuckle defining a pair of contiguous limit surfaces for engaging the underside of the hanger to restrict pivotal movement of the hanger between the retracted and extended positions, the grooves are registered with a respective one of the limit surfaces corresponding to the extended position.

According to another aspect of the invention there is provided a method of displaying at least one score of a sports match comprising:
providing a portable scoreboard with a display configured to indicate the at least one score;
hanging the portable scoreboard on chain link fencing delimiting a field of play of the sports match; and
displaying the at least one score of the sports match on the portable scoreboard.

This provides a simple arrangement for displaying score to spectators for sports matches in which the field of play is delimited by chain link fencing.

Preferably, hanging the scoreboard on the chain link fencing comprises passing hangers through openings formed by the chain link fencing.

Typically, the scoreboard is hung on the chain link fencing in an upstanding condition in which a backside of the scoreboard is in butting engagement with the chain link fencing.

Typically, the scoreboard is hung on the chain link fencing at a spaced height above a support surface on which the chain link fencing is supported. For example, the support surface may be a surface of ground material.

For example, the portable scoreboard is hung on a side of the chain link fencing facing spectators as to display the score to the spectators.

Alternatively, in another example, the portable scoreboard is hung on a side of the chain link fencing facing players of the sports match as to display the score to the players.

According to yet another aspect of the invention there is provided a portable scoreboard comprising:
a housing which is generally prismatic in shape and having a front, a back opposite to the front, a top, a bottom opposite to the top, and opposite sides;
wherein the housing is configured to be supported in upstanding condition relative to a support surface;
at least one display supported on the front of the housing and configured to indicate at least one score;
a controller supported by the housing and operatively connected to said at least one display, wherein the controller is configured to determine said at least one score to be indicated on said at least one display;
a protective cover supported on the front of the housing, wherein the protective cover is in the form of a planar body having opposite first and second sides which are substantially planar, wherein the planar body is sized and shaped to cover the at least one display, wherein the protective cover is movable between a stored position in which the planar body is covering the at least one display and a display position of the protective cover in which the planar body is disposed to one side of the at least one display as not to visually obstruct the at least one display; and
wherein the first side of the planar body is arranged to face away from the housing in the display position and arranged to receive indicia representative of an advertisement.

This provides an arrangement for protecting the display(s) when not in use and for advertising when the cover is not acting to protect the display(s).

Preferably, the protective cover is pivotally attached to the housing for pivotal movement between the stored and display positions. Thus, the first side faces the housing in the stored position.

In the illustrated arrangement, at least one of the housing and the protective cover includes magnets and the other one thereof includes mating components configured to cooperate with the magnets to maintain the protective cover in a respective one of the stored and display positions.

In the illustrated arrangement, the mating components are ferrous bodies.

In the illustrated arrangement, a corresponding one of the magnets and the mating components of the protective cover are supported in receptacles in the planar body as not to protrude beyond either the first or second side of the planar body.

In the illustrated arrangement, a set of the corresponding one of the magnets and the mating components carried by the planar body are arranged to be covered on the first side by the indicia.

In the illustrated arrangement, a set of the corresponding one of the magnets and the mating components carried by the planar body are disposed at a peripheral edge of the planar body, and portions of the peripheral edge along the mating components are thickened between the first and second sides.

In the illustrated arrangement, the receptacles supporting said set of the corresponding one of the magnets and the mating components carried by the planar body and disposed at the peripheral edge are in the form of slots opening at the peripheral edge and extending inwardly therefrom, and surrounding portions of the planar body around full perimeters of respective ones of said set of the magnets and the mating components are thickened between the first and second sides. This acts to reinforce the planar body at the slots.

In the illustrated arrangement, a corresponding set of the magnets and the mating components of the housing that is cooperative with the set of the magnets and the mating components received in the receptacles in the form of slots in the planar body are received in recesses in the front of the housing sized and shaped to receive the thickened surrounding portions of the protective cover, such that upon magnetic interaction the planar body is disposed in flush butting engagement with the front of the housing.

In the illustrated arrangement, a set of the corresponding one of the magnets and the mating components carried by the planar body are disposed at inwardly spaced positions from a peripheral edge of the planar body, wherein said set is recessed from the second side of the planar body, and a corresponding set of corresponding ones of the magnets and the mating components of the housing cooperative with said set of the protective cover are supported on the front of the housing to protrude from a surface thereof, such that upon magnetic interaction the planar body is disposed in flush butting engagement with the front of the housing.

In the illustrated arrangement, the magnets and the mating components comprise distinct cooperative sets of the magnets and the mating components for the stored and display positions.

These and other aspects are contemplated and described herein. It will be appreciated that the foregoing summary sets out representative aspects of the invention to assist skilled readers in understanding the following detailed description.

### DESCRIPTION OF THE DRAWINGS

A greater understanding of the embodiments will be had with reference to the Figures, in which:

FIG. 1 is an elevational view of an arrangement of portable scoreboard according to the invention shown in a mounted position on chain link fencing (schematically shown);

FIG. 2 is a front perspective view of the arrangement of FIG. 1 in which a protective cover of the scoreboard is in a display position;

FIG. 3 is a rear perspective view of the arrangement of FIG. 1 showing the protective cover in the display position and hangers of the portable scoreboard in retracted positions;

FIG. 4 is a rear elevation view of the arrangement of FIG. 1 in the mounted position on chain link fencing;

FIG. 5 is a side elevation view of the arrangement of FIG. 1 in the mounted position on chain link fencing;

FIGS. 6 and 7 are bottom and top views of the arrangement of FIG. 1 in the mounted position on chain link fencing which is schematically shown;

FIGS. 8 and 9 are partial cross-sectional views taken along lines 8-8 and 9-9 in FIG. 7, respectively, showing the hangers in the extended positions;

FIG. 10 shows the cross-section of FIG. 9 as a partial perspective view with the hanger in exploded relation to a housing of the portable scoreboard;

FIGS. 11 and 12 are cross-sectional views similar to FIGS. 8 and 9 but showing the hanger in a retracted position;

FIGS. 13 and 14 are front and rear elevation views of the arrangement of FIG. 1 in a stored position of the protective cover and the retracted positions of the hangers;

FIG. 15 is a side elevation view of the arrangement of FIG. 1 in the stored position of the protective cover and the retracted positions of the hangers;

FIG. 16 is a top plan view of the arrangement of FIG. 1 in the stored position of the protective cover and the retracted positions of the hangers;

FIG. 17 is a front elevation view of the arrangement of FIG. 1 in the display position of the protective cover; and

FIG. 18 is a cross-sectional view taken along line 18-18 in FIG. 17 elevation view of the arrangement of FIG. 1 in the display position of the protective cover and the retracted positions of the hangers.

### DETAILED DESCRIPTION

For simplicity and clarity of illustration, where considered appropriate, reference numerals may be repeated among the Figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

Various terms used throughout the present description may be read and understood as follows, unless the context indicates otherwise: “or” as used throughout is inclusive, as though written “and/or”; singular articles and pronouns as used throughout include their plural forms, and vice versa; similarly, gendered pronouns include their counterpart pronouns so that pronouns should not be understood as limiting anything described herein to use, implementation, performance, etc. by a single gender. Further definitions for terms may be set out herein; these may apply to prior and subsequent instances of those terms, as will be understood from a reading of the present description.

Any module, unit, component, server, computer, terminal or device exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the device or accessible or connectable thereto. Further, unless the context clearly indicates otherwise, any processor or controller set out herein may be implemented as a singular processor or as a plurality of processors. The plurality of processors may be arrayed or distributed, and any processing function referred to herein may be carried out by one or by a plurality of processors, even though a single processor may be exemplified. Any method, application or module herein described may be implemented using computer readable/executable instructions that may be stored or otherwise held by such computer readable media and executed by the one or more processors.

The accompanying figures show a portable scoreboard 100 which is particularly suited for use on or with chain link fencing 1 for displaying at least one score of a sports match.

The chain link fencing 1 generally comprises a plurality of upstanding posts 3 at spaced locations on a support surface SS; a pair of substantially horizontally extending cross-members 5 and 6 in vertically spaced-apart relation between each adjacent pair of the posts and interconnecting the respective posts of the pair; and a mesh of woven metallic wire 8 spanning between the respective posts 3 of the pair and the cross-members 5, 6 as to close an opening otherwise delimited collectively by the posts and the cross-members. The woven wire mesh 8 forms openings 11 which are commonly diamond-shaped. The fencing 1 acts to delimit a field of play of the sports match, where players of the sports match play or perform the sport, and to provide a barrier between the field of play and a spectating or viewing area where the spectators are located to watch or view the sports match. In other words, the chain link fencing acts to separate the field of play from the spectating area. Chain link fencing is a common type of barrier used in outdoor sports and advantageously permits viewing through the barrier provided thereby.

It will be appreciated that typically the posts 3 of the chain link fencing are imbedded in a material forming the support surface SS, such as ground material.

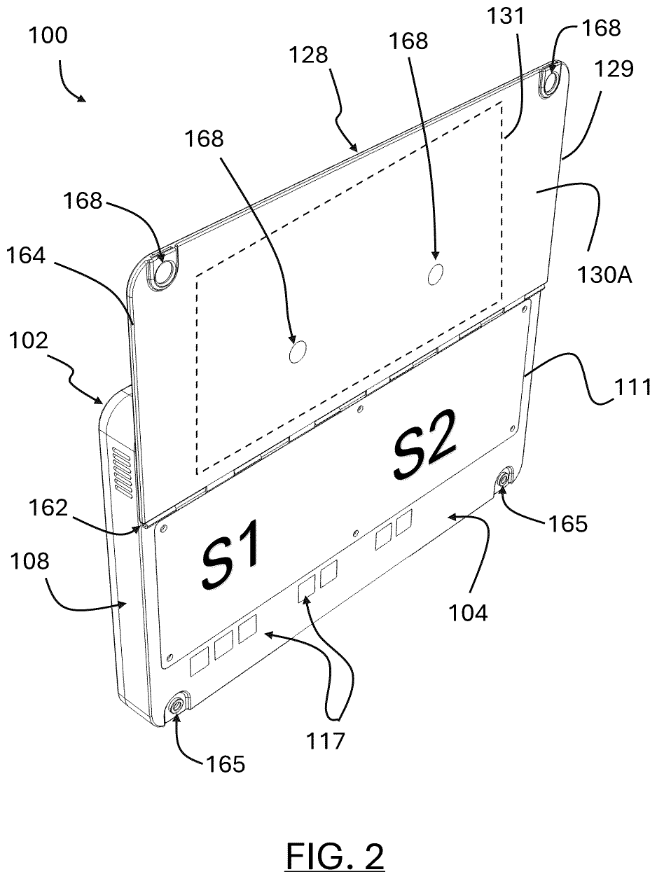

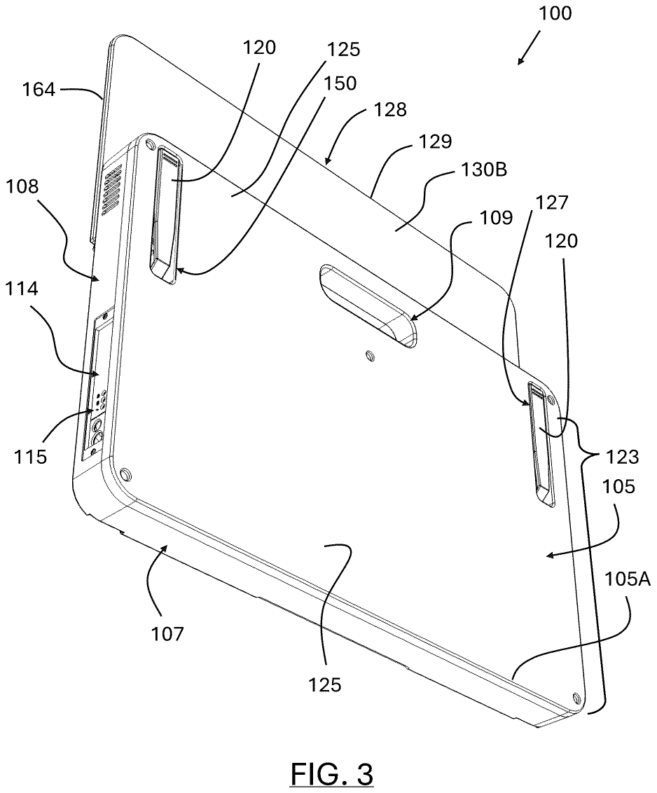

Turning now to the portable scoreboard 100, and with particular reference to FIGS. 2-3, the scoreboard comprises a housing 102 which is generally prismatic in shape and having a front 104, a back 105 opposite to the front, a top 106, a bottom 107 opposite to the top, and laterally opposite sides 108. The shape of the housing is generally prismatic in that an exterior thereof resembles a prism though the housing may have recesses, cutouts, or protrusions causing its outer peripheral surface not to be prismatic per se. In the illustrated arrangement, the housing is generally rectangular prismatic in shape. Further, the housing is configured, in particular by being sized, to be carried by a person as to be portable. To aid portability, the scoreboard includes a handle 109 formed in the back 105 of the housing, essentially as a laterally elongated receptacle sized to receive a user's fingers, and disposed closer to the top 106 than to the bottom 107. In other arrangements of portable scorebard, the handle may be formed through a full depth of the housing between the front and the back as to be in the form of a hole.

The scoreboard 100 further comprises at least one display 111 supported on the front 104 of the housing and configured to indicate at least one score, typically in the form of one or more digits, and a controller 114 supported by the housing 102 and operatively connected to the at least one display. The controller 114 is configured to determine the at least one score to be indicated on the at least one display.

In the illustrated arrangement, the at least one display 111 comprises a single display configured to indicate plural scores, typically two, such as S1 and S2, representative of different teams engaged or participating in the sports match (normally competing against each other); however, in other arrangements, the at least one display may comprise plural displays respectively configured to indicate a different one of the teams'scores.

The controller 114 is supported by the housing 102, for example, by being mounted substantially inside the housing. In the illustrated arrangement, the controller 114 comprises at least one processor and at least one non-transitory memory operatively connected thereto, and is configured to wirelessly connect to a portable computing device, such as a smartphone, to receive instructions therefrom about the at least one score to be indicated on the at least one display, for example, by way of an application executed on the portable computing device. The controller 114 is configured to store data, including the instructions, received from the portable computing device in its at least one non-transitory memory.

The portable scoreboard also includes external controls 115, in particular a power button, accessible at an exterior of the housing, such as at one of the sides 108. The power button acts to turn on or off electrically powered components of the portable scoreboard, such as the at least one display 111 and the controller 114. As such, the housing of the portable scoreboard is arranged to contain one or more electrical energy storage elements, such as batteries, arranged to be electrically connected to the electrical components of the scoreboard, for example, the at least one display and the controller, and configured to deliver electrical power thereto.

To provide further information about a status of the sports match, and in addition to the display 111, the illustrated arrangement of scoreboard comprises visual indicators 117, such as lights, that are selectively activatable, for example to illuminate, and arranged to indicate aspects of the status of the match, such as time period of play and turns of the sports match. For example, in a baseball game, the visual indicators are provided in plural groupings representative of a different one of ball, strike and out. In the example of baseball, each of the groupings of the visual indicators comprises plural individual lights. In addition to the visual indicators, the scoreboard may include indicia associated with the visual indicators and indicating the aspect of the status of the match represented thereby, such as ‘Ball’, ‘Strike’ and ‘Out’ in the case of baseball. When the portable scoreboard comprises the visual indicators 117, they are also operatively connected to the controller 114 such that the controller is configured to determine activation of the visual indicators responsive to the data received from the portable computing device. Further, it will be appreciated that in some arrangements the visual indicators may be in the form of displays configured to indicate numerals representative of status of the sports match besides scores which are displayed on the at least one display 111. Yet further, it will be appreciated that the at least one display 111 and the visual indicators 117 may be parts of a common circuit board to which the controller 114 is operatively connected.

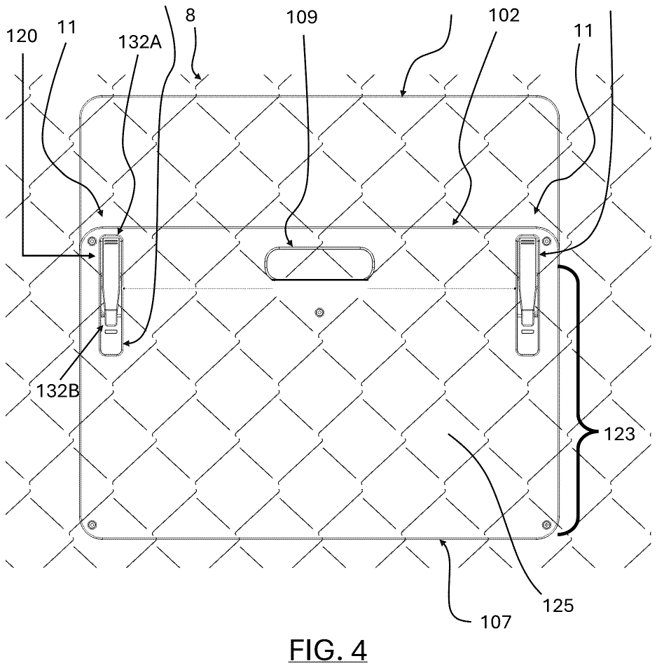

To be presented in a position for viewing during the match, the scoreboard 100 comprises plural hangers 120 supported on the back 105 of the housing for passing through the openings 11 formed by the woven wire mesh 8 of the chain link fencing to hang the housing 102 thereon, as more clearly shown in FIGS. 3 and 4.

Furthermore, a lower portion 123 of the back of the housing between the hangers 120 and the bottom 107 is arranged to engage the chain link fencing to cooperate with the hangers (when extended) in the mounted position of the scoreboard. More specifically, the lower portion comprises a portion of a surface 125 of the back 105, which is below the hangers 120 and above or extending therefrom up to the bottom 105, presented for butting engagement with the woven wire mesh 8 of the chain link fencing in the mounted position, as more clearly shown in FIG. 4. Thus, the back or rear surface 123 acts to rest against the chain link fencing as to maintain the housing in an upstanding condition when hung by the hangers on the fencing. In the illustrated arrangement, the lower portion 123 spans from a height on the back that registers with attachment points 127 of the hangers to the housing, from which they extend outwardly to pass through the woven wire mesh's openings 11, and to a bottom edge 105A of the back 105 contiguous with the bottom 107 of the housing, which is shown more clearly in FIG. 3.

To protect the display, at least in view of the scoreboard's portability, the scoreboard 100 further comprises a protective cover 128 supported on the front 104 of the housing. The protective cover 128 is in the form of a planar body 129 having opposite first and second sides 130A, 130B which are substantially planar. That is, the planar body 129 is substantially in the form of a rigid sheet having a thickness between the first and second sides. The planar body 129 is sized and shaped to cover the one or more displays 111. That is, in an arrangement in which the scoreboard comprises multiple score-indicating displays, the planar body 129 is sized and shaped to cover all of the multiple displays.

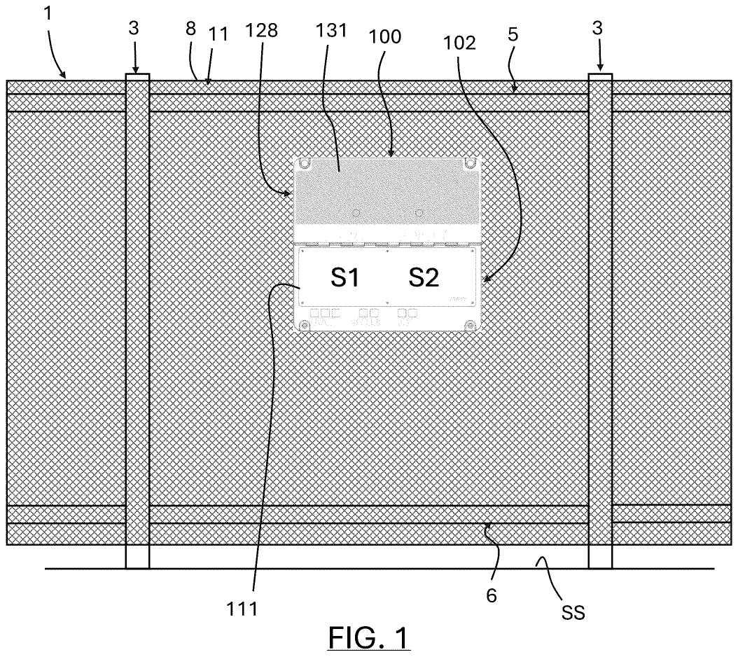

To selectively reveal the display(s) 111 during use of the scoreboard to display one or more scores of a sports match, the cover 128 is movable between a stored position in which the planar body 129 is covering the display(s), as shown for example in FIG. 13, and a display position of the protective cover in which the planar body is disposed to one side of the display(s) as not to visually obstruct the same, as shown for example in FIG. 1.

Further, the first side 130A of the planar body is arranged to face away from the housing 102 in the display position and arranged to receive indicia 131 representative of an advertisement, which is shown as a transparent shaded area in FIG. 1 and as a stippled border in FIG. 2 to otherwise reveal the first side 130A thereunder.

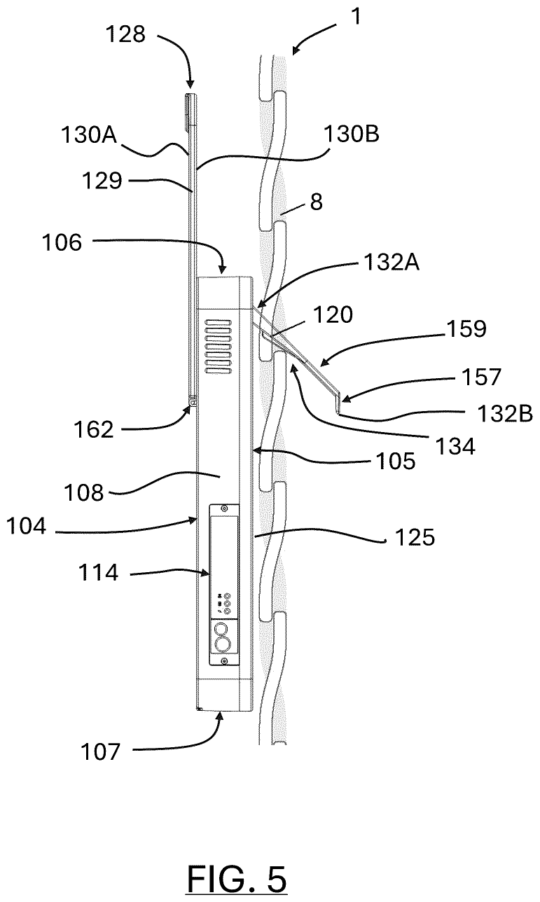

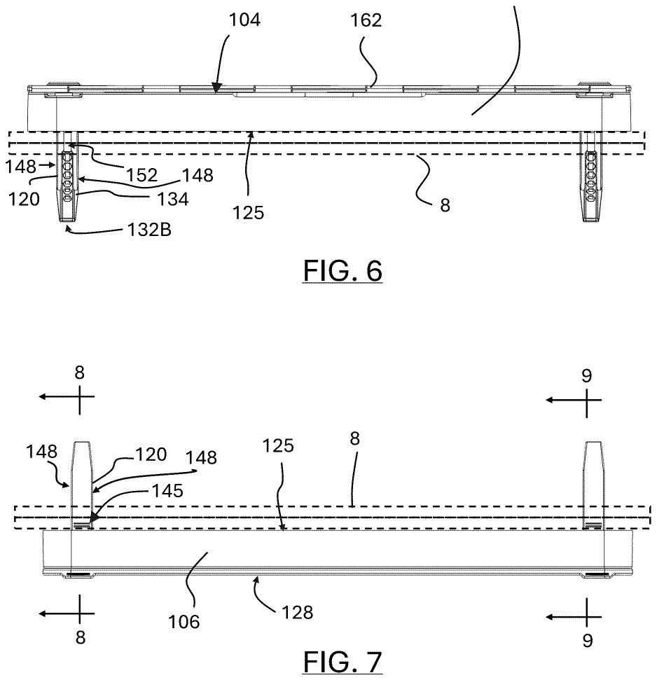

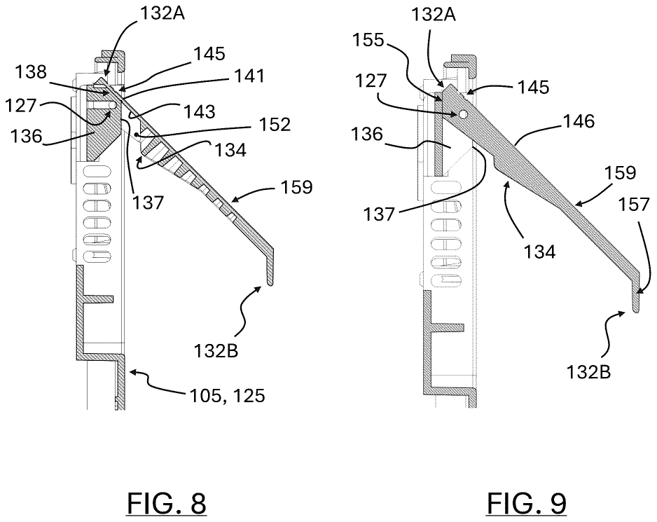

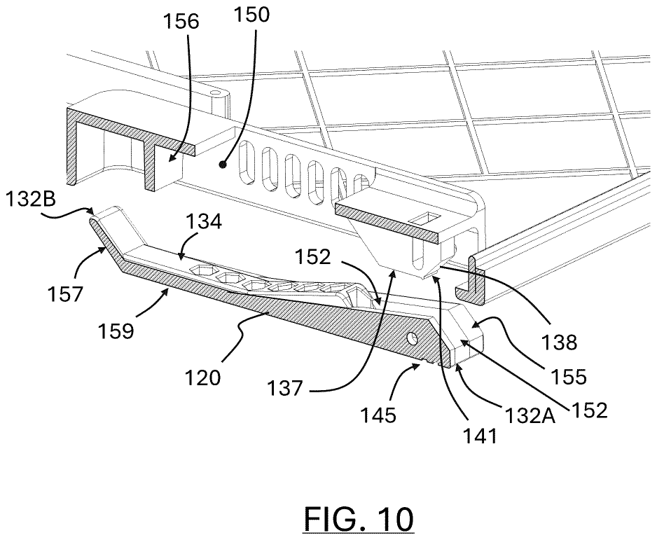

Turning now to the hangers 120 in more detail, and with reference to FIGS. 4-5, the hangers are in the form of fingers each having a proximal end 132A at or adjacent the attachment point 127 of the finger to the housing (more clearly shown in FIGS. 8-9) and an opposite distal end 132B which is free. The hangers 120 are respectively movable relative to the housing 102 between a retracted position in which the distal end 132B is located at or adjacent a surface 125 of the back 105 of the housing, as shown for example in FIG. 3, and an extended position in which the distal end 132B is in outwardly spaced relation to the surface 125 of the back of the housing to provide an underside 134 of the hanger for engaging the chain link fencing in a mounted position of the scoreboard, as shown for example in FIGS. 4-7.

In the illustrated arrangement, the hangers 120 are pivotally attached to the housing 102, and the housing 102 includes, for each hanger 120, a knuckle 136 defining a pair of contiguous limit surfaces 137, 138 for engaging the underside 134 of the hanger to restrict pivotal movement thereof between the retracted and extended positions. A first one of the limit surfaces corresponding to the retracted position, and in this case indicated at 137, is substantially parallel to the back 105 of the housing, such that in the retracted position the hanger is positioned substantially parallel to the back of the housing with the distal end 132B disposed at or adjacent the back surface 125, and the other one of the limit surfaces corresponding to the extended position, and in this case indicated at 138, is disposed above the first limit surface 137 and is inclined relative thereto and to the back of the housing so that the hanger extends outwardly and downwardly from the back of the housing to locate the distal end 132B in spaced relation thereto. An interior angle between the two limit surfaces 137, 138 is obtuse such that in the extended position of the hanger an acute interior angle is formed between the underside 134 of the hanger and the back 105 of the housing. The hanger 120 is considered to be substantially parallel in the retracted position in that a majority length of the hanger which is linearly extending is disposed parallel to the housing's back 105.

In the illustrated arrangement, the knuckle 136 includes a ridge 141 between respective ones of the pair of limit surfaces 137, 138 and an interior face 143 of the underside of the hanger is planar such that the ridge 141 acts to bias the hanger 120 against pivotal movement between the retracted and extended positions. That is, the ridge 141 is located at an intersection of the limit surfaces 137, 138 as to be disposed at an apex of the knuckle.

To assist in overcoming the biasing produced by the ridge 141, each hanger 120 includes plural grooves 145 in an outer surface 146 of the hanger opposite to the underside 134, which respectively extend between opposite sides 148 of the hangers and are disposed in spaced relation to each other in a longitudinal direction between the proximal and distal ends 132A, 132B to be arranged for gripping engagement by a user's fingers. Furthermore, the grooves 145 are disposed closer to the proximal end 132A than to the distal end 132B of the hanger, and more specifically, the grooves are registered with the second limit surface 138 corresponding to the extended position, since an upper portion 149 of the hanger above the pivotal attachment point 127 and between the same and the proximal end 132A is shorter in length than a lower portion of the hanger below the attachment point and between the same and the distal end 132B.

In the illustrated arrangement, each knuckle 136 is received in a receptacle 150 in the back 105 of the housing to be recessed relative to the surface 125 thereof, and the underside 134 of each hanger has a cutout 152 configured to mateably receive the knuckle 136 in the retracted position such that the outer surface 146 of the hanger is substantially flush with the surface 125 of the back of the housing in the retracted position. The receptacle 150 is sized to receive the respective hanger such that the outer surface 146 thereof is arranged substantially flush with the back surface 125 of the housing. In the illustrated arrangement, the outer surface 146 of each hanger along a majority length thereof lies in a common plane with the back surface 125 of the housing which is planar in the illustrated arrangement, as to be flush therewith in the retracted position.

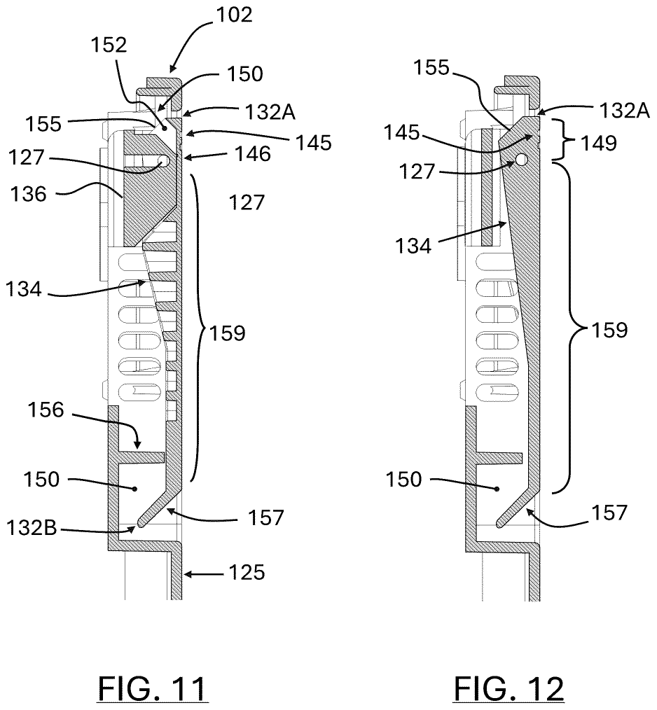

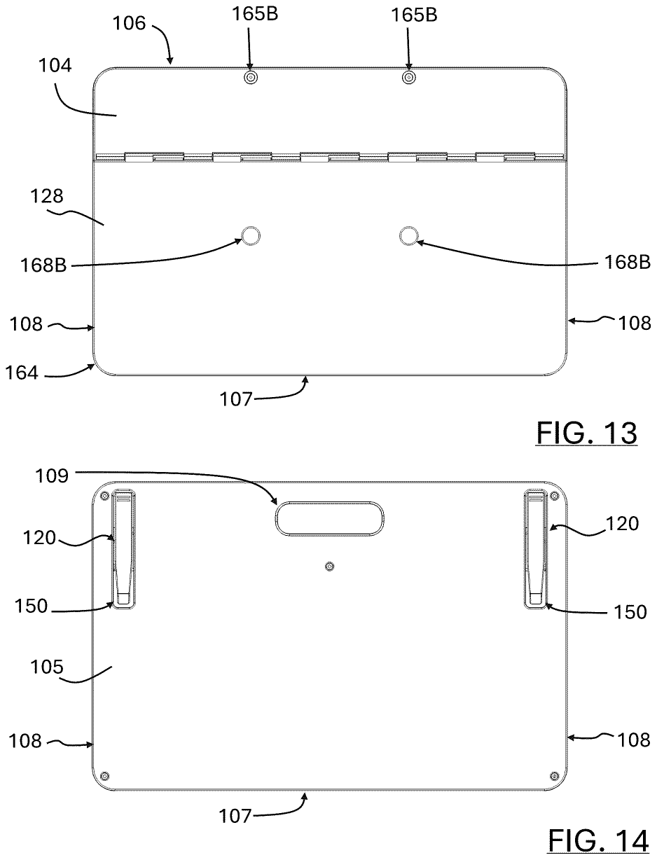

The cutouts 152 are enlarged relative to the knuckles 136 proximal to the proximal ends 132A of the hangers to provide clearance for pivotal movement to the extended position, as more clearly shown in FIG. 11. As such, in the retracted position there is formed a gap between the underside 134 at an upper end portion of the cutout 152 and the second limit surface 138 corresponding to the extended position. Similarly, in the extended position there is formed a gap between the underside 134 at a lower end portion of the cutout 152 and the first limit surface 137.

It will be appreciated that the undersides 134 of the hangers 120 include a plurality of wells between the cutouts 152 and the distal ends 132B to reduce an amount of material and improve cooling during an extrusion process, since the hangers 120 preferably comprise plastics material.

Further, and referring back to FIGS. 8-9, each hanger at the proximal end 132A thereof has an inclined end surface 155 between the underside 134 and the outer surface 146 and configured to engage the housing in the extended position. The end surface 155 is inclined relative to the outer surface 146 of the hanger, which is substantially parallel to the back 105 in the retracted position. As such, the respective hanger is further braced or supported in the extended position.

The scoreboard further includes stops 156 distinct from the knuckles 136 for butting engagement with the undersides 134 of the hangers in the retracted position. The stops 156 are disposed in spaced relation to the knuckles 136 to engage the hangers at intermediary locations thereon between the proximal and distal ends 132A, 132B. Thus, the respective hanger is further braced or supported in the retracted position.

To resist removal of the scoreboard from the mounted position on the fencing, the hangers 120 include distal end portions 157, which define the distal ends 132B, extending transversely from intermediate portions 159 of the hangers to form hooks or hooked ends of the hangers. That is, when the intermediate portions 159 between the proximal and distal ends 132A, 132B extend downwardly and outwardly from the back 105 of the housing in the extended position, the distal end portions extend downwardly from the intermediate portions in the extended position.

Though there are plural hangers which are independently movable between the retracted and extended positions, more than one of the hangers 120 is arranged in the respective extended position to mount the scoreboard on the chain link fencing (in the mounted position thereof). Further, in a storage position of the scoreboard in which the scoreboard is removed from the chain link fencing 1 to be separated therefrom (and in spaced relation), all of the hangers 120 are arranged in the retracted position to reduce a volume or footprint occupied by the scoreboard.

Turning now to the protective cover 128 in more detail, the planar body 129 of the illustrated arrangement of scoreboard is pivotally attached to the housing 102 for pivotal movement between the stored and display positions, such that the cover is in the form of a flap. More specifically, the cover 128 has a pivot axis 162 extending laterally between the opposite sides 108 and which is substantially horizontally-oriented. Thus, the first side 130A, which receives the advertising indicia 131, faces the housing 102 in the stored position. Accordingly, the second side 130B faces away from the housing in the stored position, and in the display position, it is oriented generally towards the housing.

In the illustrated arrangement, the display(s) 111 and the visual indicators 117 operated in conjunction therewith to indicate a status of the match, including the score, occupy a majority portion of an area of the front 104 of the housing, and accordingly, the planar body 129 of the cover is sized to cover a majority of the housing's front 104. Further, the pivot axis 162 is disposed closer to the top 106 of the housing than to the bottom 107 thereof. Yet further, the planar cover body 129 is arranged to pivot upwardly from the stored position to the display position, and to pivot downwardly from the display position to the stored position. Thus, in the display position thereof, the cover 128 protrudes above the top 106 of the housing in the display position, as more clearly shown in FIG. 5. In the stored position, a peripheral edge 164 of the planar body 129, besides a portion thereof along the axis 162, is substantially aligned with the sides 108 and the bottom 107 of the housing, such that the housing and the cover arranged in the stored position are collectively generally prismatic in shape, and in this case, rectangular prismatic, like the housing. As such, in the stored position, the cover is substantially indistinguishable from the housing since the shape of the scoreboard is substantially the same as the housing alone (free of, that is without, the cover).

To maintain the respective stored and display positions of the cover, at least one of the housing 102 and the protective cover 128 includes magnets 165A, 165B and the other one thereof includes mating components 168A, 168B configured to cooperate with the magnets 165A, 165B to maintain the protective cover in a respective one of the stored and display positions. In the illustrated arrangement, the housing 102 carries magnets only and the protective cover 128 carries mating components only (such that neither has a combination of both types of cooperative devices for cooperating with corresponding cooperative devices on the other substrate).

Furthermore, in the illustrated arrangement, there are distinct cooperative sets of the magnets and the mating components for the stored and display positions. That is, each of the cover and the housing have a separate set of either magnets or mating components for each operating position of the cover. For example, a first set of the magnets indicated at 165A is in use, that is, causing physical abutment of the cover to the housing by magnetic attraction of a nearby mating component, in the stored position of the cover, while a second set of the magnets indicated at 165B is not in use. Further, the second set of magnets 165B is in use in the display position of the cover, in which position the first set of magnets 165A is not in use.

In the illustrated arrangement, the magnets 165A, 165B are permanent magnets, and the mating components 168A, 168B are ferrous bodies, which more specifically are in the form of plates, and in this case discs. These may be referred to in industry as ‘strike plates.’

The mating components of the protective cover are supported in receptacles 171A, 171B in the planar body 129 as not to protrude beyond either the first or second side 130A, 130B thereof. In the illustrated arrangement, both first and second sets of the mating components 168A, 168B respectively corresponding to the stored and display positions of the cover are received in receptacles in the planar body.

The first set of mating components indicated at 168A and corresponding to the stored position of the cover are disposed at the peripheral edge 164 of the planar body, and portions of the peripheral edge along the mating components 168A are thickened between the first and second sides 130A, 130B. The receptacles supporting the first set of mating components, in this case those indicated at 171A, are in the form of slots opening at the peripheral edge 164 and extending inwardly therefrom. That is, the slots extend within the planar body 129 as to be formed within the thickness thereof. Surrounding portions 173 of the planar body around full perimeters of the first set of mating components, including the portion along the peripheral edge 164, are thickened between the first and second sides 130A, 130B. This acts to reinforce the planar body at the slots.

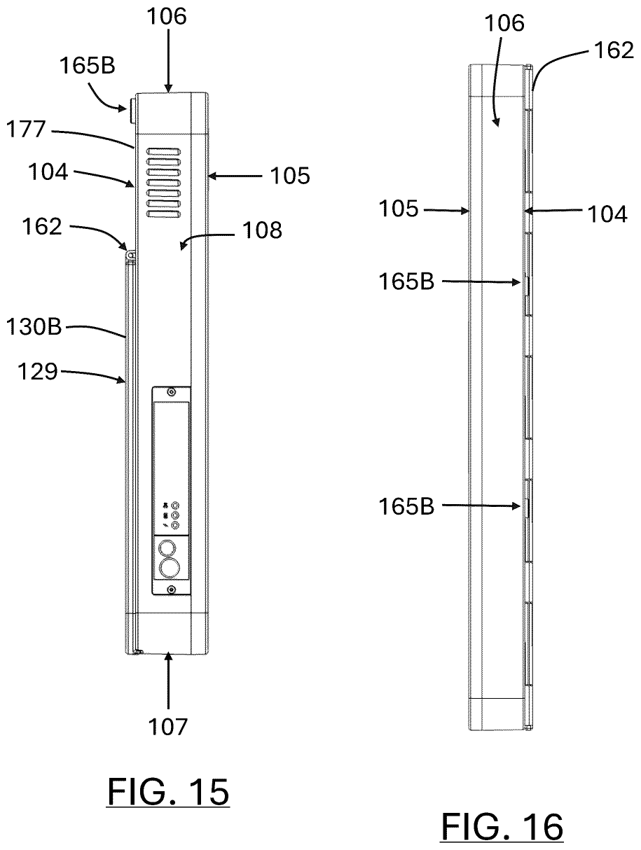

To mate with the cover in the stored position thereof, respective ones of the first set of the magnets 165A are received in recesses 171B in the front 104 of the housing that are sized and shaped to receive the thickened surrounding portions of the protective cover, such that upon magnetic interaction the planar body 129 is disposed in flush butting engagement with the front 104 of the housing, as more clearly shown in FIG. 15.

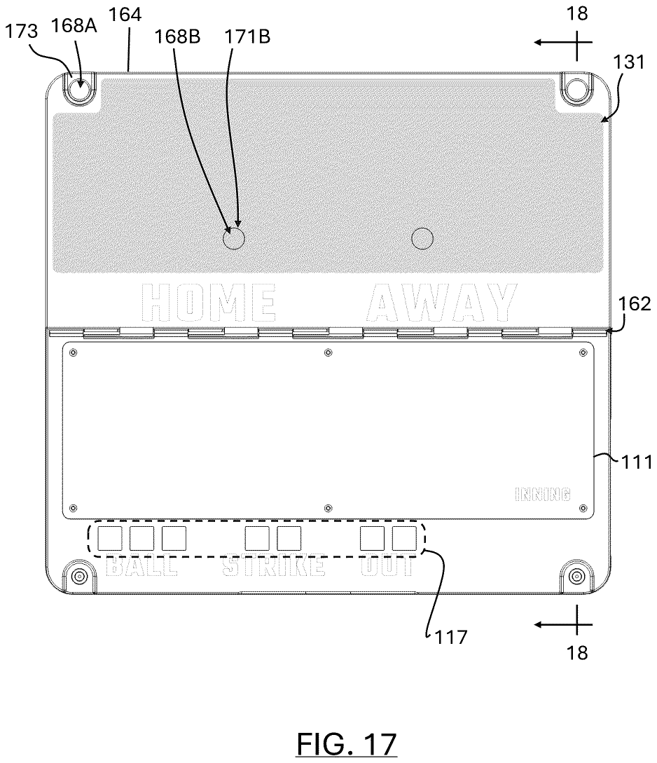

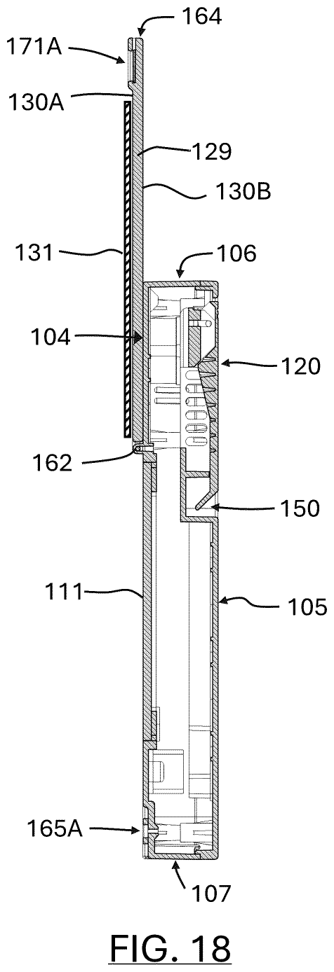

The second set of mating components indicated at 168B and corresponding to the display position are disposed at inwardly spaced positions from the peripheral edge 164 of the planar body. Respective mating components of the second set 165B are recessed from the second side 130B of the planar body, and respective ones of the second set of magnets 165B are supported on the front 104 of the housing to protrude from a surface 177 thereof, such that upon magnetic interaction the planar body 129 is disposed in flush butting engagement with the front 104 of the housing, as shown in FIG. 16 for example.

The second set of mating components 168B are arranged to be covered on the first side 130A by the indicia 131 as not to be visible in the display position.

The indicia 131 is in the form of a substrate attached to the first side 130A of the planar body, for example by adhesion.

Thus, is provided an arrangement of scoreboard suited for hanging on chain link fencing to display score(s).

Further, the foregoing provides an arrangement for protecting the display(s) when not in use and for advertising when the cover is not acting to protect the display(s).

There is also disclosed herein a method of displaying at least one score of a sports match comprising the general steps of:
providing a portable scoreboard with a display configured to indicate the at least one score;
hanging the portable scoreboard on chain link fencing delimiting a field of play of the sports match; and
displaying the at least one score of the sports match on the portable scoreboard.

Hanging the scoreboard on the chain link fencing comprises passing hangers through openings formed by the woven wire mesh of the chain link fencing.

Generally speaking, the scoreboard is hung on the chain link fencing in an upstanding condition in which the backside 105 of the scoreboard is in butting engagement with the chain link fencing. Further, the scoreboard is hung on the chain link fencing at a spaced height above a support surface on which the chain link fencing is supported. For example, the support surface may be a surface of ground material.

The portable scoreboard may be hung on a side of the chain link fencing facing spectators as to display the score to the spectators, or the portable scoreboard is hung on a side of the chain link fencing facing players of the sports match as to display the score to the players.

This provides a simple arrangement for displaying score to spectators for sports matches in which the field of play is delimited by chain link fencing.

Displaying the score is performed by operating a portable computing device wirelessly connected to the controller of the portable scoreboard and using a downloadable application on the portable computing device to select the score to be shown on the scoreboard.

As described hereinbefore, the present invention relates to a portable scoreboard comprising a generally prismatic shaped housing, a display(s) supported on the front of the housing and configured to indicate a score(s), and a controller supported by the housing and operatively connected to the display(s) to determine the score(s) to be indicated thereon. The scoreboard features hangers on the back of the housing for passing through openings formed by woven wire of the fencing to hang the housing thereon. A lower portion of the housing back is arranged to engage the fencing to cooperate with the hangers in the scoreboard's mounted position. The scoreboard also features a protective cover supported on the housing front and movable relative thereto between a stored position covering the display(s) and a display position disposed to one side thereof as not to be visually obstructing. A side of the cover facing away from the housing in the display position is arranged to receive advertisement indicia.

While the aspects of the present embodiments are illustrated and described as having a certain arrangement of aspects and features, it is understood that any suitable arrangement can be used that retains the functions described with respect to the present embodiments.

Although the foregoing has been described with reference to certain specific embodiments, various modifications thereto will be apparent to those skilled in the art without departing from the spirit and scope of the invention as outlined in the appended claims.

1. A portable scoreboard for use with chain link fencing having a mesh of woven wire, the portable scoreboard comprising:
a housing which is generally prismatic in shape and having a front, a back opposite to the front, a top, a bottom opposite to the top, and opposite sides;
at least one display supported on the front of the housing and configured to indicate at least one score;
a controller supported by the housing and operatively connected to said at least one display, wherein the controller is configured to determine said at least one score to be indicated on said at least one display; and
hangers supported on the back of the housing for passing through openings formed by the mesh of woven wire of the chain link fencing to hang the housing thereon, wherein the hangers are in the form of fingers each having a proximal end at or adjacent an attachment point of the finger to the housing and an opposite distal end which is free, wherein the hangers are respectively movable relative to the housing between a retracted position in which the distal end is located at or adjacent a surface of the back of the housing and an extended position in which the distal end is in outwardly spaced relation to the surface of the back of the housing to provide an underside of the hanger for engaging the chain link fencing in a mounted position of the scoreboard;
wherein a lower portion of the back of the housing between the hangers and the bottom is arranged to engage the chain link fencing to cooperate with the hangers in the mounted position of the scoreboard.

2. The portable scoreboard of claim 1 wherein the hangers are pivotally attached to the housing and the housing includes, for each hanger, a knuckle defining a pair of contiguous limit surfaces for engaging the underside of the hanger to restrict pivotal movement of the hanger between the retracted and extended positions.

3. The portable scoreboard of claim 2 wherein the knuckle includes a ridge between respective ones of the pair of limit surfaces and an interior face of the underside of the hanger is planar such that the ridge acts to bias the hanger against pivotal movement between the retracted and extended positions.

4. The portable scoreboard of claim 2 wherein each knuckle is received in a receptacle in the back of the housing to be recessed relative to the surface thereof and the underside of each hanger has a cutout configured to mateably receive the knuckle in the retracted position such that an outer surface of the hanger, opposite to the underside thereof, is substantially flush with the surface of the back of the housing in the retracted position.

5. The portable scoreboard of claim 4 wherein the cutouts are enlarged relative to the knuckles proximal to the proximal ends of the hangers to provide clearance for pivotal movement to the extended position.

6. The portable scoreboard of claim 2 further including stops distinct from the knuckles for butting engagement with the undersides of the hangers in the retracted position, wherein the stops are disposed in spaced relation to the knuckles to engage the hangers at intermediary locations thereon between the proximal and distal ends.

7. The portable scoreboard of claim 2 wherein each hanger at the proximal end thereof has an inclined end surface between the underside and an outer surface and configured to engage the housing in the extended position.

8. The portable scoreboard of claim 1 wherein in the extended position the hangers extend outwardly and downwardly from the back of the housing.

9. The portable scoreboard of claim 8 wherein, when the hangers have intermediate portions between the proximal and distal ends extending downwardly and outwardly from the back of the housing in the extended position, the hangers further include distal end portions, which define the distal ends, extending downwardly from the intermediate portions in the extended position to form hooks.

10. The portable scoreboard of claim 1 wherein each hanger includes plural grooves in an outer surface thereof opposite to the underside, wherein the grooves respectively extend between opposite sides of the hangers and are disposed in spaced relation to each other in a longitudinal direction between the proximal and distal ends to be arranged for gripping engagement by a user's fingers.

11. The portable scoreboard of claim 10 wherein the grooves are disposed closer to the proximal end than to the distal end of the hanger.

12. The portable scoreboard of claim 11 wherein, when the hangers are pivotally attached to the housing and the housing includes, for each hanger, a knuckle defining a pair of contiguous limit surfaces for engaging the underside of the hanger to restrict pivotal movement of the hanger between the retracted and extended positions, the grooves are registered with a respective one of the limit surfaces corresponding to the extended position.

13. A method of displaying at least one score score of a sports match comprising:
providing a portable scoreboard with a display configured to indicate the at least one score;
hanging the portable scoreboard on chain link fencing delimiting a field of play of the sports match; and
displaying the at least one score of the sports match on the portable scoreboard.

14. A portable scoreboard comprising:
a housing which is generally prismatic in shape and having a front, a back opposite to the front, a top, a bottom opposite to the top, and opposite sides;
wherein the housing is configured to be supported in upstanding condition relative to a support surface;
at least one display supported on the front of the housing and configured to indicate at least one score;
a controller supported by the housing and operatively connected to said at least one display, wherein the controller is configured to determine said at least one score to be indicated on said at least one display;
a protective cover supported on the front of the housing, wherein the protective cover is in the form of a planar body having opposite first and second sides which are substantially planar, wherein the planar body is sized and shaped to cover the at least one display, wherein the protective cover is movable between a stored position in which the planar body is covering the at least one display and a display position of the protective cover in which the planar body is disposed to one side of the at least one display as not to visually obstruct the at least one display; and
wherein the first side of the planar body is arranged to face away from the housing in the display position and arranged to receive indicia representative of an advertisement.

15. The portable scoreboard of claim 14 wherein the protective cover is pivotally attached to the housing for pivotal movement between the stored and display positions.

16. The portable scoreboard of claim 14 wherein at least one of the housing and the protective cover includes magnets and the other one thereof includes mating components configured to cooperate with the magnets to maintain the protective cover in a respective one of the stored and display positions.

17. The portable scoreboard of claim 16 wherein the mating components are ferrous bodies.

18. The portable scoreboard of claim 16 wherein a corresponding one of the magnets and the mating components of the protective cover are supported in receptacles in the planar body as not to protrude beyond either the first or second side of the planar body.

19. The portable scoreboard of claim 18 wherein a set of the corresponding one of the magnets and the mating components carried by the planar body are arranged to be covered on the first side by the indicia.

20. The portable scoreboard of claim 18 wherein a set of the corresponding one of the magnets and the mating components carried by the planar body are disposed at a peripheral edge of the planar body, and portions of the peripheral edge along the mating components are thickened between the first and second sides.

21. The portable scoreboard of claim 20 wherein the receptacles supporting said set of the corresponding one of the magnets and the mating components carried by the planar body and disposed at the peripheral edge are in the form of slots opening at the peripheral edge and extending inwardly therefrom, and surrounding portions of the planar body around full perimeters of respective ones of said set of the magnets and the mating components are thickened between the first and second sides.

22. The portable scoreboard of claim 20 wherein a corresponding set of the magnets and the mating components of the housing that is cooperative with the set of the magnets and the mating components received in the receptacles in the form of slots in the planar body are received in recesses in the front of the housing sized and shaped to receive the thickened surrounding portions of the protective cover, such that upon magnetic interaction the planar body is disposed in flush butting engagement with the front of the housing.

23. The portable scoreboard of claim 18 wherein a set of the corresponding one of the magnets and the mating components carried by the planar body are disposed at inwardly spaced positions from a peripheral edge of the planar body, wherein said set is recessed from the second side of the planar body, and a corresponding set of corresponding ones of the magnets and the mating components of the housing cooperative with said set of the protective cover are supported on the front of the housing to protrude from a surface thereof, such that upon magnetic interaction the planar body is disposed in flush butting engagement with the front of the housing.

24. The portable scoreboard of claim 16 wherein the magnets and the mating components comprise distinct cooperative sets of the magnets and the mating components for the stored and display positions.
